(19) United States
(12) Patent Application Publication
(10) Pub. No.: US 2008/0231045 A1
(43) Pub. Date: Sep. 25, 2008

(54) Quick-Action Coupling for Pipes

(75) Inventors: Michael Trede, Habsheim (FR); Axel Feger, Lorrach (DE)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/090,286

(22) PCT Filed: Sep. 20, 2006
(86) PCT No.: PCT/EP06/09118

§ 371 Date: Apr. 15, 2008

(30) Foreign Application Priority Data
Nov. 18, 2005 (DE) DE102005055549.7

(51) Int. Cl. F16L 35/00; F16L 37/12; F16L 37/084; F16L 37/14

(52) U.S. Cl. 285/93

(57) ABSTRACT

A coupling has a locating part (1) into which a plug-in part can be inserted, and a locking part (7) which, after insertion of the plug-in part, can be moved from a projecting prefitting position into a pushed-in locking position. There is a control part (12) which has a C-shaped basic body formed with side legs (13, 14) and encloses, in the prefitting position of the locking part (7), a section (16) of the locating part (1). The control part (12) comprises a stop section (18), which, in the prefitting position of the locking part (7), bears in a stop position against the locking part (7) and which, in the locking position of the locking part (7), is disengaged from the locking part (7), wherein the control part (12), in the locking position of the locking part (7) can be displaced in the axial direction from the stop position into a removal position, in which it can be removed from the locating part (1). As a result, the proper connection of the plug-in part and the locating part (1) can be controlled in a simple manner.

### RELATED APPLICATION

This application is a U.S. National Phase patent application based on International Application Serial No. PCT/US2006/009118 filed Sep. 20, 2006, the disclosure of which is hereby explicitly incorporated by reference herein.

### BACKGROUND OF THE INVENTION

1. Field of the Invention

The present invention concerns a coupling.

2. Description of the Related Art

One coupling is known from DE 10 2004 062 887 B3. The prior coupling is provided with a receiving part, into which can be inserted an insertion part configured with a radially projecting retaining ring. Also present is a locking part, which after insertion of the insertion part into a coupling position can be moved from a protruding, pre-assembly position, in which radially inward movement otherwise is blocked, to a pushed-in, locking position in which radially outward movement is blocked. The locking part is provided with axially movable locking arms, which in cooperation with locking projections make it possible to assume the pre-assembly and locking positions in which movement is blocked. In this way, the assembly force can be influenced by relatively simple structural means, high wear resistance is obtained, and simple and reliable handling is afforded when releasing the connection between the receiving part and the insertion part, especially under tight spatial conditions.

### SUMMARY OF THE INVENTION

The present invention provides a coupling by means of which it can be verified in a simple manner that the locking part has been properly shifted from the protruding, pre-assembly position into the pushed-in, locking position for properly connecting the insertion part and the receiving part.

By virtue of the fact that in the coupling according to the invention, a verifying part is present that can be taken off the receiving part by displacement in the axial direction only if the locking part is properly disposed in the pushed-in, locking position, a simple control is created, in that, for example during assembly on an assembly line, a worker responsible for uniting the receiving part and the insertion part can make certain that a proper fluid connection has been established in all the assembled couplings by counting the number of removed verifying parts and comparing the number of verifying parts with the number of assembled couplings.

In one form thereof, the present invention provides a coupling including a receiving part into which can be inserted an insertion part configured with a radially protruding retaining ring, and including a locking part, which, after insertion of the insertion part into a coupling position, can be moved from a protruding, pre-assembly position, in which radially inward movement is blocked, into a pushed-in, locking position, in which radially outward movement is blocked, in order to fix the insertion part by engagement behind the retaining ring, characterized in that a verifying part having a C-shaped basic body formed with side legs is present, which verifying part in the pre-assembly position of the locking part embraces a section of the receiving part, and is provided with a stop section which in the pre-assembly position of the locking part bears in a stop position against the locking part and which in the locking position of the locking part is free of engagement with the locking part, and in that in the locking position of the locking part, the verifying part can be displaced in the axial direction from the stop position into a removal position in which it can be taken off the receiving part.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an exemplary embodiment of a coupling according to the invention, with a locking part disposed in a protruding, pre-assembly position and a verifying part in stop position;

FIG. 2 is a perspective view of the exemplary embodiment according to FIG. 1, with the locking part in a pushed-in, locking position and an insertion part inserted in a receiving part;

FIG. 3 is a perspective view of the exemplary embodiment according to FIGS. 1 and 2, with a verifying part displaced in the axial direction from the stop position according to FIG. 1; and

FIG. 4 is a perspective view of the exemplary embodiment according to FIGS. 1 to 3, with the verifying part in a removed arrangement.

Corresponding reference characters indicate corresponding parts throughout the several views. Although the exemplification set out herein illustrates an embodiment of the invention, the embodiment disclosed below is not intended to be exhaustive or to be construed as limiting the scope of the invention to the precise forms disclosed.

### DETAILED DESCRIPTION

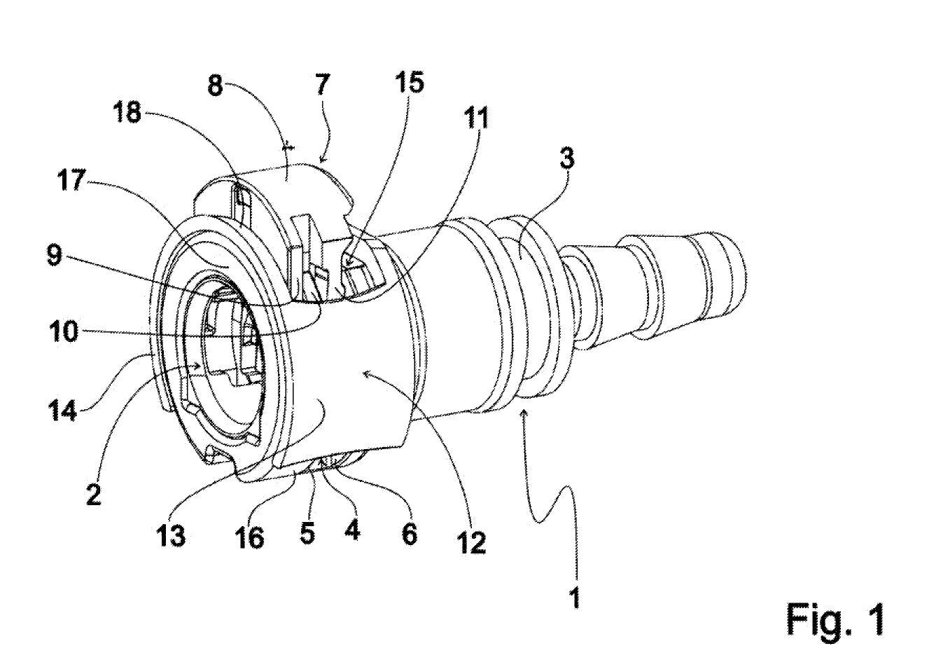

FIG. 1 is a perspective view of an exemplary embodiment of a coupling according to the invention. The coupling according to FIG. 1 is provided with a receiving part 1 made of a hard plastic material and able to be connected, by an end not shown in FIG. 1, to a line of a fluid line system. On the receiving part 1, configured on both sides of an elongate receiving body 3, in a region of enlarged cross section adjacent an insertion end 2, are locking arm receptacles 4 extending at right angles to the axial direction of the receiving body 3. Disposed as a blocking element on each of the front walls 5 facing toward the insertion end 2 is a locking projection (not visible in the representation of FIG. 1), which stands out in the axial direction from the respective front wall 5 and extends in the direction of a rear wall 6 located opposite the front wall 5, a clearance being formed between the free end of the particular locking projection, i.e. the end pointing away from the insertion end 2, and the particular rear wall 6.

The coupling according to the invention is further provided with a locking part 7, also made of a hard plastic material, which is configured with a cover section 8 onto which are formed two mutually opposite retaining arms 9. The retaining arms 9 each engage in a respective retaining-arm receptacle that is separated by a partition 10 from the locking-arm receptacles 4 and is disposed on the side of the locking-arm receptacles 4 facing away from the insertion end 2.

In the exemplary embodiment shown, locking part 7 is further provided with two locking arms 11, which engage in the locking-arm receptacles 4 and which, by virtue of the properties of the plastic material used and/or suitable dimensioning, are flexible in their dimensions in the axial direction. The locking arms 11 are preferably biased to the insertion end 2, and in the representation of FIG. 1 therefore bear, at least in the region of their free ends, by their flat sides facing the insertion end 2 against the front walls 5 of locking-arm receptacles 4.

In the arrangement of receiving part 1 and locking part 7 depicted in FIG. 1, in which locking part 7 is in a protruding, pre-assembly position, the end faces of the free ends of the locking arms 11, which end faces act as additional blocking elements of the blocking arrangement, bear against the sides facing them of the walls of the locking projections, causing the locking part 7, in this pre-assembly position in which it protrudes above receiving body 3, to be blocked against radially inward movement, i.e. against displacement into a pushed-in, locking position, by the preferred biasing of the locking arms 11 in the direction of insertion end 2.

Configured, moreover, in the region of the free end of each locking arm 11 is a respective radially inwardly open locking receptacle that is complementary in shape to the respective locking projection.

Further present in the coupling according to the invention is a verifying part 12 having a C-shaped basic body configured with side legs 13, 14 and a locking-part opening 15. In the arrangement according to FIG. 1, in the pre-assembly position of the locking part 7, the verifying part 12 embraces a head section 16 in which the verifying part 7 is also seated, with the locking part 7 engaging through the locking-part opening 15. Verifying part 12 comprises a stop section, which in the described exemplary embodiment is formed by a connecting web 18 that extends in a circular-arc shape between the side legs 13, 14 and bears against a terminating collar 17 carried by head section 15 and facing toward insertion end 2. In the arrangement according to FIG. 1, connecting web 18, in the protruding, pre-assembly position of locking part 7, rests directly against the wall of locking part 7 that faces toward insertion end 2.

In a not illustrated modification of a coupling according to the invention, there is a given distance between a stop section and the locking part 7.

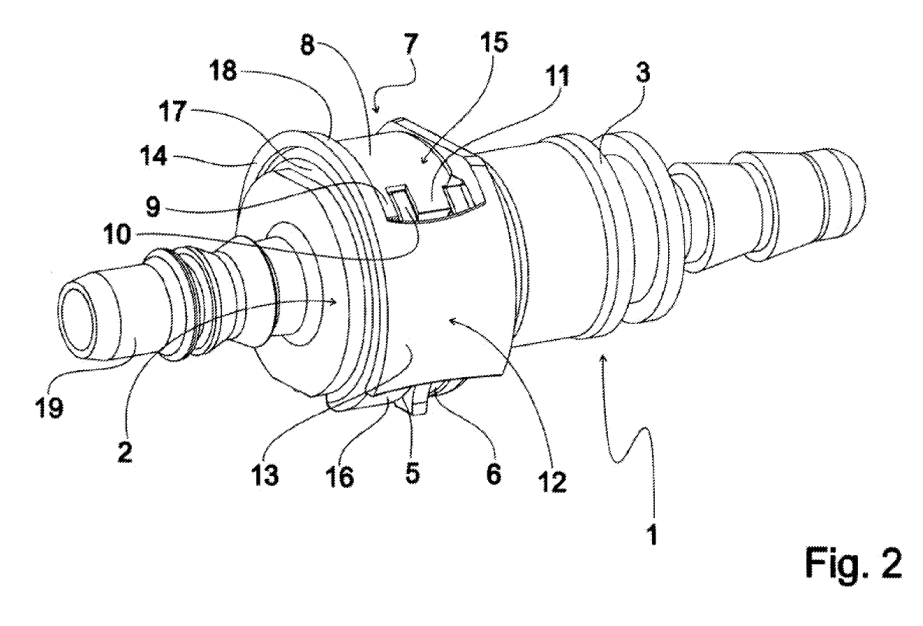

FIG. 2 is a perspective view of the receiving part 1 and the locking part 7 of the described exemplary embodiment of a coupling according to the invention in the arrangement according to FIG. 1, with an insertion part 19 inserted by an insertion shaft into a receiving space surrounded by receiving body 3. The insertion shaft is sealed by means of a sealing arrangement. The insertion part 19 is further configured with a retaining ring that is larger in diameter than the insertion shaft, and, to make the connection to the fluid line system, a connecting shaft formed on the opposite side of the retaining ring from the insertion shaft.

In the arrangement according to FIG. 2, the insertion part 19, for proper connection to the receiving part 1, is properly inserted deep enough into the receiving space to arrive at a coupling position, which is the only arrangement in which an engagement of the end faces of the free ends of the locking arms 11 with the locking projections that prevents locking part 7 from being shifted from the extended, pre-assembly position according to FIG. 1 to the pushed-in, locking position shown in FIG. 2 is released, accompanied by movement of the locking arms 11 against the bias, in the axial direction away from insertion end 2.

The pushed-in, locking position superseded the protruding, pre-assembly position shown in FIG. 1 as follows: by the exertion of a suitable force on cover section 8, the locking arms 11 moved far enough through the clearances so that due to the bias of locking arms 11, the locking receptacles came into engagement with the locking projections and fixed the locking part 7 in this pushed-in, locking position that immobilizes it against radially outward movement. In the pushed-in locking position, the retaining arms 9 engage behind the retaining ring and thereby lock insertion part 19 in receiving part 1. To avoid excessive play in this movement, the clearances are usefully configured as only slightly larger, in their dimensions in the axial direction, than the thickness of the locking arms 11.

If, on the contrary, locking part 7 is not shifted from the protruding, pre-assembly position according to FIG. 1 into the pushed-in, locking position according to FIGS. 2 to 4, the then relatively high bias of the locking arms 11 causes the insertion part 19 to be expelled toward the insertion end 2, against the direction of insertion. High assembly reliability is thereby achieved.

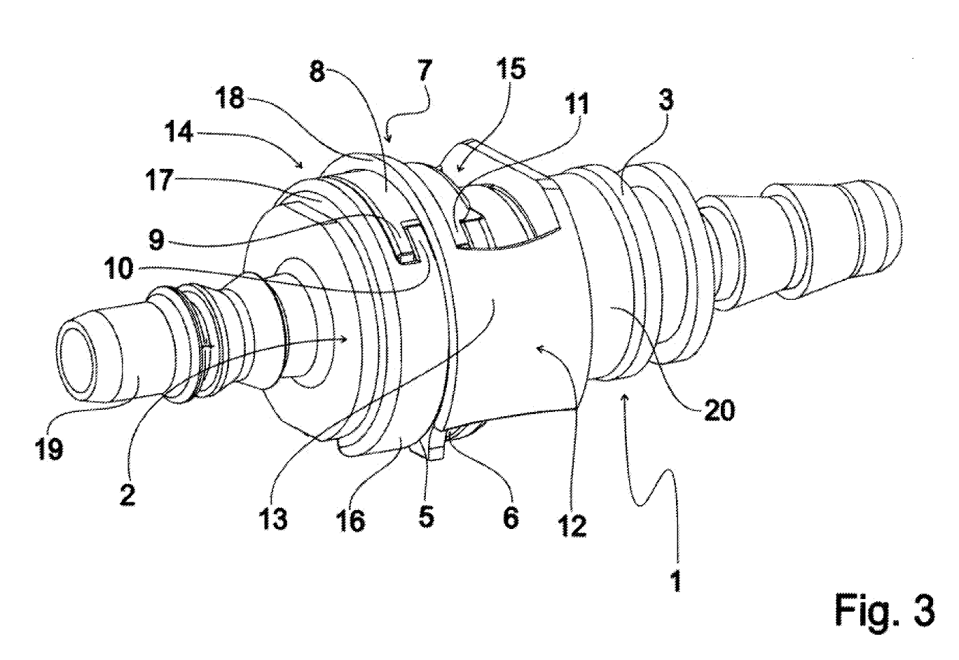

FIG. 3 is a perspective view of the exemplary embodiment according to FIGS. 1 and 2 with the locking part in the pushed-in, locking position. It is apparent from FIG. 3 that in the described exemplary embodiment, the outside of cover section 8 is disposed flush with terminating collar 17, so the connecting web 18 is now exposed and, as illustrated in FIG. 3, the verifying part 12 can be slid away from the insertion end 2 in the direction of a midsection 20 that is disposed after head section 16 in the insertion direction of insertion part 17.

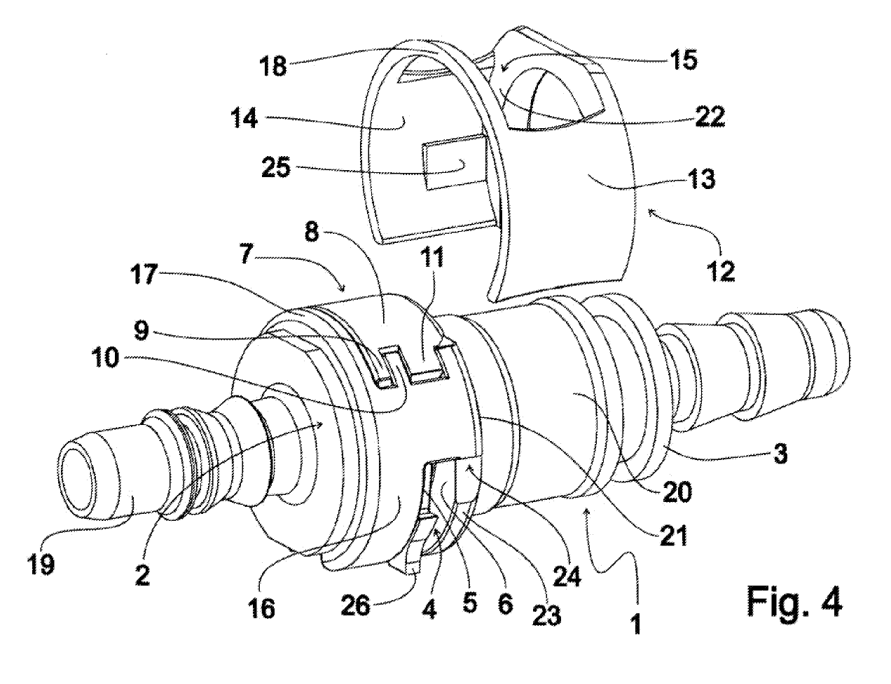

FIG. 4 shows the exemplary embodiment according to FIGS. 1 to 3 with verifying part 12 removed from receiving body 3, after verifying part 12 has been pushed past midsection 20. It is clear from FIG. 4 that midsection 20 has a smaller diameter than head section 16, a radially oriented stepped wall 21 being formed between head section 16 and midsection 20. It can further be appreciated from FIG. 4 that verifying part 12 has on its opposite side from connecting web 18 a radially inwardly projecting rear wall 22, which is configured such that its radially inward-oriented face rests against an edge portion of midsection 20 that is adjacent stepped wall 21 and is thickened slightly in comparison to the other regions of midsection 20. For one thing, this strengthens verifying part 12 against bending open, and for another thing, verifying part 12 is held without play on receiving body 3 in the stop position, whereas it is relatively easy to remove from receiving body 3 after being shifted into a removal position in which is disposed in the region of midsection 20 and is free of engagement with head section 16.

It can further be appreciated from FIG. 4 that to prevent verifying part 12, in the stop position of FIG. 1, from being accidentally removable from receiving body 3 by a rotating movement, snap-in grooves 24 that extend in the axial direction and are open to midsection 20 are provided in a head collar 23 carried by head portion 15 and disposed adjacent stepped wall 21, and snap-in projections 25 that are complementary to said snap-in grooves 24 are formed on the inner faces of side legs 13, 14.

The free ends 26 of the locking arms 11 usefully protrude slightly beyond the region of receiving part 1 that is slightly increased in diameter compared to receiving body 3, such that when a force is exerted on the protruding end portions of the locking arms 11 in the axial direction away from insertion end 2, against the bias of locking arms 11, the engagement between the locking projections and the locking receptacle is released, and by the exertion of another force directed perpendicular to this unlocking force and in the direction of cover section 9, locking part 7 can be shifted from the pushed-in, locking position into the protruding, pre-assembly position, in which insertion part 19 can be withdrawn again from receiving part 1.

Hence, due to this necessity of exerting two forces in different directions and at separate times, a very reliable connection is established between the receiving part 1 and the insertion part 19, one that virtually eliminates the possibility of accidental release.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-5. (canceled)

6. A coupling, comprising:
a receiving part including a radially protruding retaining ring;
an insertion part couplingly insertable into said receiving part;
a locking part associated with said receiving part, said locking part movable between a radially protruding pre-assembly position in which radially inward movement of said locking part is initially blocked, and a radially inward locking position in which radially outward movement of said locking part is blocked, said locking part fixing said insertion part within said receiving part in said locking position by engagement behind said retaining ring; and
a verifying part having a C-shaped body formed with a pair of side legs, said verifying part in said pre-assembly position embracing a section of said receiving part, said verifying part provided with a stop section which, in said pre-assembly position, bears against said locking part and which in said locking position is free of engagement with said locking part, said verifying part displaceable in said locking position in an axial direction along said receiving part from said stop position to a removal position in which said verifying part is removable from said receiving part.

7. The coupling of claim 6, wherein said stop section is formed by a connecting web which, in said stop position, is positioned forward of said locking part with respect to an insertion direction of said insertion part into said receiving part.

8. The coupling of claim 7, wherein said receiving part includes a head section disposed in front of said insertion part in said insertion direction, and a midsection disposed behind said head section in said insertion direction, said midsection having a smaller diameter than said head section, and wherein in said stop position, said verifying part is disposed on said head section.

9. The coupling of claim 8, wherein said verifying part includes a rear wall projecting inwardly from said side legs, said rear wall bearing against a stepped wall formed between said head section and said midsection in said stop position.

10. The coupling of claim 9, wherein said head section includes axially extending snap-in grooves, and said verifying part includes snap-in projections which engage in said snap-in grooves in said stop position.
